(19) United States
(12) Patent Application Publication
(10) Pub. No.: US 2006/0022794 A1
(43) Pub. Date: Feb. 2, 2006

(54) Identification with RFID asset locator for entry authorization

(76) Inventors: Gary E. Determan, Maple Grove, MN (US); Bruce W. Anderson, Andover, MN (US)

Correspondence Address: Kris T. Fredrick;Patent Services, Honeywell International Inc., 101 Columbia Road, Morristown, NJ, 07962, US

(21) Appl. No.: 10/901,410

(22) Filed: Jul. 27, 2004

(51) Int. Cl. H04Q 1/00; G05B 19/00

(52) U.S. Cl. 340/5.52; 340/5.61

(57) ABSTRACT

A system for controlling access at secure facilities to locations and assets contained in those locations, comprising a biometric identification device, an RFID tag and receiver, and a database for processing information from them to allow or deny access to the locations and assets. The system ties into an existing network in the facility and also includes a programming device for evaluation of the biometric template and acknowledgement of the identification, if made. The system also controls the permissible locations of assets such as laptops, desktop computers, photographic equipment, weapons such as rifles, data storage devices and the like, such that while a person may have access to a location, use of an asset or removal of the asset may not be part of that person's authorized conduct.

### FIELD OF THE INVENTION

The present invention relates in general to a system using biometric information from persons in combination with a radio frequency identification device and, more particularly, to a system for maintaining control over access to secure areas and to control of movement of valued assets.

### BACKGROUND OF THE INVENTION

A secure building typically has many types of access that need to be controlled. It has become impractical to have a guard on station at every access point, particularly where doors are locked unless and until proper access is provided. Even buildings that employ human guards at the main entrance do not find the cost of several dozen or more guards at various other locations to be practical or affordable. Many times valuable assets are removed without the knowledge of the guard. An example would be someone carrying out a laptop. It would be an advantage if an alarm would protect the asset. The most common form of access control to these other areas are card readers and key pads.

The problems with card readers are that they are expensive and only as secure as the person possessing the card. Anyone having the card can gain access to the area. A lost or stolen card is a serious security issue.

The problem with keypads is the need to protect and maintain the keypad combinations. Combinations can be stolen or guessed, particularly if the individual does not use a random selection. A stolen combination could be used for an extended period of time before the theft is detected.

There have been some efforts to use other methods than card readers and keypads. Ortiz et al. Publication No. 2003/0163710 discloses a system using biometric authentication using fingerprint, iris and other identities, sometimes in combination, to identify the user. Ortiz also discloses the use of RFID tags such as on badges. Access is either permitted or denied. The reference simply seeks to authenticate a person's identity, for use with ATMs, banks, work stations and the like. Ortiz et al. does not seek to protect assets from being moved from one location to another.

Kocher Publication No. 2004/0002894 discloses an identification system using three factors of authentication, including iris and fingerprint, for use with RFID units. A first identification uses the RFID unit, then biometric identity is presented and identified. If positive, a third factor consisting of a special position of the biometric is compared to the actual position. A match gains access. Again asset location does not appear to be disclosed and access is the only requirement being determined.

Bowers et al. Publication No. 2001/0000019 discloses the use of RFID tags in a library or other place for handling articles in which each book or other object has its own tag that can be accessed as needed to determine its presence or absence. One advantage of Bowers et al is the ability to determine use of the book within the facility by checking locations during open hours to provide data on which books are consulted but not checked out.

Finally, Hsu et al. U.S. Pat. No. 6,041,410 discloses a key fob with biometric identification.

It would be of great advantage if a system could be developed that would combine entry and egress needs of persons in conjunction with various assets that the person or persons may need to use, to move, or to do both.

Another advantage would be if a system using biometrics could be simple and economically integrated into facility control of personnel and the facility assets that is assigned to each such person for use or transportation.

Yet another advantage would be a system using biometrics and RFID technology in which the signals being transmitted are encrypted to prevent tampering or interception of the signals by others seeking to defeat the system.

Other advantages and features will appear hereinafter.

### SUMMARY OF THE INVENTION

The present invention provides a system for controlling access at secure facilities to locations and assets contained in those locations. Typical locations are banks, research facilities, prisons, military facilities, hospitals and other treating centers, clinics, factories, offices and the like. The assets include laptops, desktop computers, photographic equipment, weapons such as rifles, data storage systems and groups thereof.

The system includes a location at a secure facility and having an access door controlled by a lock mechanism and at least one asset contained in the location, the asset having an asset RFID tag mounted thereon to permit or deny access to the asset, such as a computer, and also permit or deny removal of the asset, such as a firearm, from the location by the person having access to the location. The system could also be integrated with the asset to disarm or lock the asset if it is removed.

A biometric identification device is positioned for access by a person to read at least one biometric feature of a person. Examples of biometric features can include iris, retina, fingerprint, tissue hydration, optical patent length differences, DNA, and skin oil.

The person carries a personal RFID tag adapted to interact with the biometric device and transmit readings from the biometric device to an RFID receiver for receiving and transmitting signals based on signals from any RFID tag in the system. The RFID receiver signal is processed by a programmable device such as a computer and includes a comparator for comparing biometric data from the RFID signal with a biometric data base or template. The comparator determines the existence or absence of an approved identification from an access database in the database. Upon determining an approved identification, the signal is adapted to selectively contact the locking mechanism to permit entry into the location and to permit or deny access to the at least one asset via the asset RFID tag.

### BRIEF DESCRIPTION OF THE DRAWINGS

For a more complete understanding of the invention, reference is hereby made to the drawings, in which:

FIG. 1 is a schematic diagram of the present invention showing the system; and

FIG. 2 is a schematic diagram of details of the system shown in FIG. 1 used to implement biometric data flow.

In the figures, like reference characters designate identical or corresponding components and units throughout the several views.

### DETAILED DESCRIPTION OF THE PREFERRED EMBODIMENT

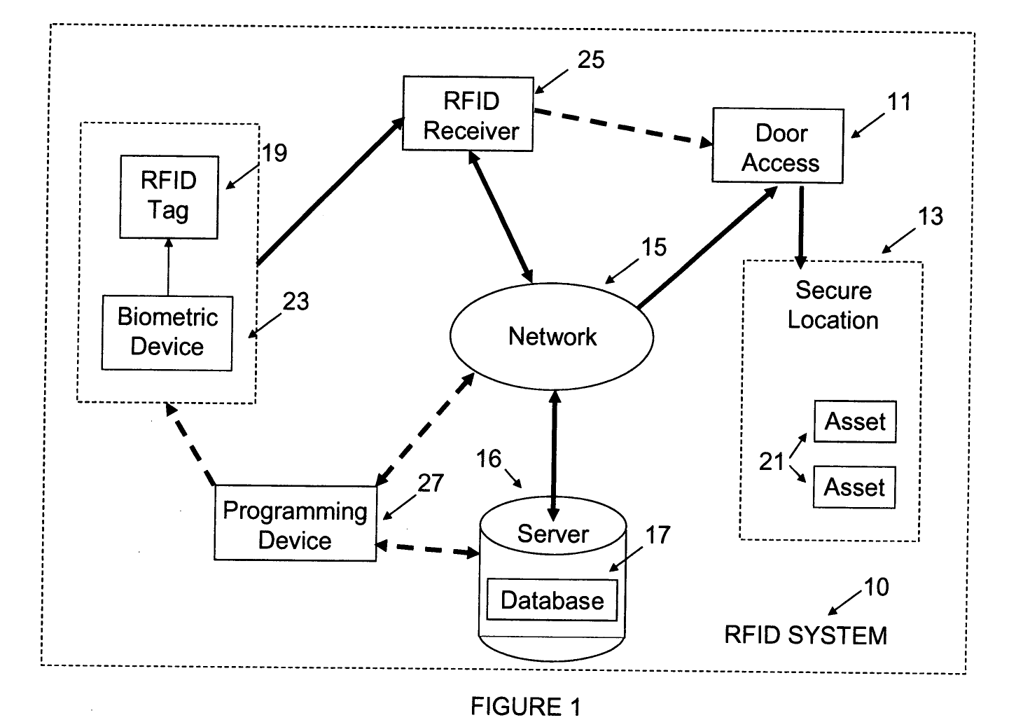

Referring to the figures, FIG. 1 shows the system, 10 generally, in which a secure location in a facility has a door access control mechanism 11 which permits or denies access to the location 13 by locking or unlocking control mechanism 11. A network 15 is in operable relationship with a server having a server 16 and database 17. A RFID tag 19 is provided to each individual who may have reason to access location 13 through door access control mechanism 11 and to use at least one asset 21 in the secure location 13. Tag 19 communicates with a biometric device 23 and signals a RFID receiver 25, which in turn communicates with the network 15 and database 17.

Examples of biometric features can include iris, retina, fingerprint, tissue hydration, optical patent length differences, DNA, and skin oil. In the case of an iris scan, for example, the person activates the scanner with his or her tag 19 and looks into device 23. The data is transmitted to the receiver 25 and processed. Biometric feature templates are stored in the database 17.

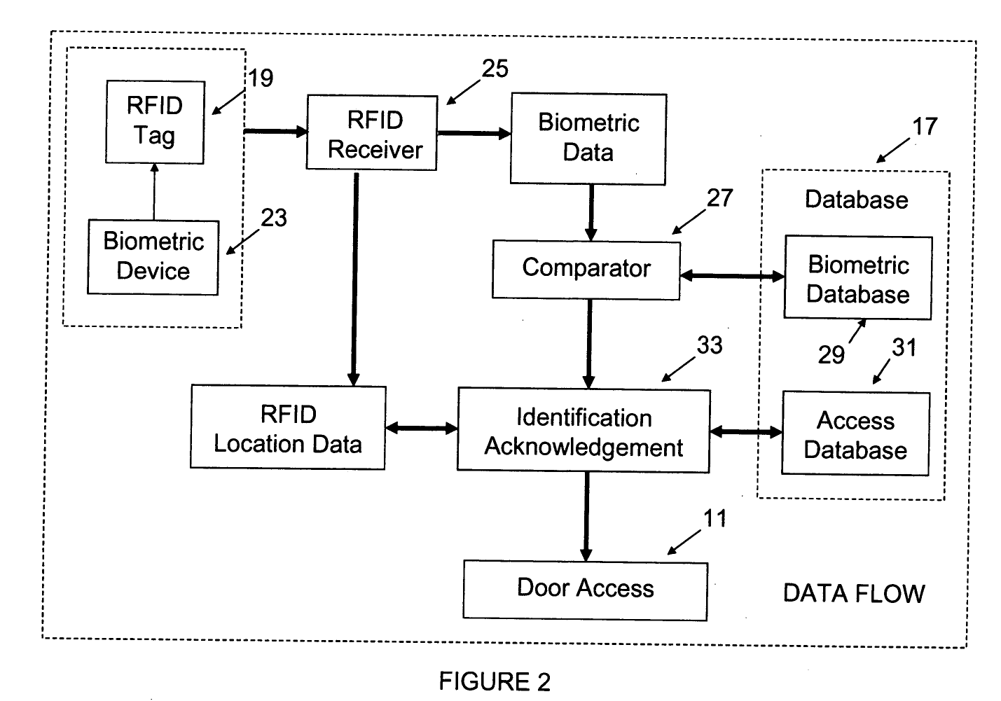

The RFID tag 19 communicates with the RFID receiver 25. The receiver 25 communicates with the database 17 through the network 15. Then either the server controls the door access 11 or it can be controlled by the nearest RFID receiver 25. This would be preferred if the network failures. A programming device 27 shown in FIG. 2 is needed to enroll and add templates to the biometric device if there were biometric information stored on the RFID tag, such as a finger print. It would not be necessary if the person put his or her finger or fingers on a biometric fingerprint reader that would transmit the fingerprint to the receiver 25. Then the enrollment would be done on the server 16 or through the network to the server.

Referring to FIG. 2, the biometric template is collected at device 23 and passed through the receiver 25, then to the comparator 27. Comparator 27 compares the template to the templates stored in the database 17 and looks for a match. The template information may be stored in several locations. One would be a server 16 where everyone's data is stored. It could also be stored in the RFID tag 19 since there would only be one tag per person or one template stored in the device. Another location for the template would be the RFID Receiver 25 where it could have all of the templates for the all of the people that have access to the door it controls.

Once a match has been found the system needs to check to see if the person has access privileges to the door that is at the location. This information as well could be on the server 16 or even in the RFID Tag 19, or only the doors the specific RFID tag can open. The most reasonable place would be the RFID receiver 25 since it determines the location of the asset 21. Once the receiver gets both the ID and it has access the server 16 or the receiver 25 would open the door 11 to location 13. In many facilities, all of the doors are hardwired to the main controller in the network 15. Another way is to have the door 111 wired to the RFID receiver 25 which would control it.

The RFID Tag 19 could be on a person or a valuable asset 21 that would not be allowed to be removed unless the person moving the asset 21 could be biometrically identified. For example, a person may have access to a computer or laptop, or some other valuable asset, to perform data entry, make calculations, and the like, but would not have permission to remove the asset, thus preventing the taking data outside a secure location. If, for example, the assets were firearms in a prison, only assigned guards would be able to take the firearm from the store room or armory, and an alarm would sound if an unauthorized person took the firearm. A smart firearm could also be disabled.

There are many possibilities for secure control of access to locations and use and/or movement of valuable assets. The system of this invention permits protection of places and things by permitting or denying access to them by persons who have been biometrically screened for such access.

While particular embodiments of the present invention have been illustrated and described, they are merely exemplary and a person skilled in the art may make variations and modifications to the embodiments described herein without departing from the spirit and scope of the present invention. All such equivalent variations and modifications are intended to be included within the scope of this invention, and it is not intended to limit the invention, except as defined by the following claims.

1. A system for controlling access at secure facilities to locations and assets contained in those locations, comprising;
a location at a secure facility and having an access door controlled by a lock mechanism;
at least one asset contained in said location, said asset having an asset RFID tag mounted thereon;
a biometric identification device positioned for access by a person, said biometric device being adapted to read at least one biometric feature of a person;
a personal RFID tag adapted to interact with said biometric device and transmit readings from said biometric device;
an RFID receiver for receiving and transmitting signals based on signals from any RFID tag in said system; and
a database for processing information from said RFID receiver to allow or deny access to the locations and assets.

2. The system of claim 1, wherein said biometric device is adapted to read at least one biometric feature selected from the group consisting of iris, retina, fingerprint, tissue hydration, optical patent length differences, DNA, and skin oil.

3. The system of claim 1, wherein said system includes a programmable device adapted to process said RFID receiver signals.

4. The system of claim 3, wherein said programmable device includes a comparator for comparing biometric data from said RFID signal with a biometric data base, said comparator determining the existence or absence of an approved identification from an access database in said database, and providing a signal upon determining an approved identification, said signal being adapted to selectively contact said locking mechanism to permit entry into said location and to permit access to said at least one asset via said asset RFID tag.

5. The system of claim 4, wherein said comparator provides a first signal for selectively permitting entry into said location and a second signal permitting access to said at least one asset.

6. The system of claim 5, wherein said second signal is further adapted to also permit or deny removal of said at least one asset from said location.

7. The system of claim 1, wherein said at least one asset is selected from the group consisting of laptops, desktop computers, photographic equipment, weapons such as rifles, data storage systems and groups thereof.

8. A system for controlling access at secure facilities to locations and assets contained in those locations, comprising;
a location at a secure facility and having an access door controlled by a lock mechanism;
at least one asset contained in said location, said asset having an asset RFID tag mounted thereon;
means for making a biometric identification positioned for access by a person, said biometric device being adapted to read at least one biometric feature of a person;
a personal RFID tag adapted to interact with said biometric device and transmit readings from said biometric device;
RFID receiver means for receiving and transmitting signals based on signals from any RFID tag in said system; and
database means for processing information from said RFID receiver means to allow or deny access to the locations and assets.

9. The system of claim 8, wherein said biometric means is adapted to read at least one biometric feature selected from the group consisting of iris, retina, fingerprint, tissue hydration, optical patent length differences, DNA, and skin oil.

10. The system of claim 9, wherein said system includes a programmable means for processing said RFID receiver signals.

11. The system of claim 10, wherein said programmable means includes comparator means for comparing biometric data from said RFID signal with a biometric data base, said comparator means determining the existence or absence of an approved identification from an access database in said database means, and providing a signal upon determining an approved identification, said signal being adapted to selectively contact said locking mechanism to permit entry into said location and to permit access to said at least one asset via said asset RFID tag.

12. The system of claim 11, wherein said comparator means provides a first signal for selectively permitting entry into said location and a second signal permitting access to said at least one asset.

13. The system of claim 12, wherein said second signal is further adapted to permit or deny removal of said at least one asset from said location.

14. The system of claim 8, wherein said at least one asset is selected from the group consisting of laptops, desktop computers, photographic equipment, weapons such as rifles, data storage systems and groups thereof.

15. A system for controlling access at secure facilities to locations and assets contained in those locations, comprising;
a location at a secure facility and having an access door controlled by a lock mechanism;
at least one asset contained in said location, said asset having an asset RFID tag mounted thereon;
a biometric identification device positioned for access by a person, said biometric device being adapted to read at least one biometric feature of a person selected from the group consisting of iris, retina, fingerprint, tissue hydration, optical patent length differences, DNA, and skin oil;
a personal RFID tag adapted to interact with said biometric device and transmit readings from said biometric device;
an RFID receiver for receiving and transmitting signals based on signals from any RFID tag in said system;
a programmable device adapted to process said RFID receiver signals, said programmable device including a comparator for comparing biometric data from said RFID signal with a biometric data base, said comparator determining the existence or absence of an approved identification from an access database in said database, and providing a signal upon determining an approved identification, said signal being adapted to selectively contact said locking mechanism to permit entry into said location and to permit access to said at least one asset via said asset RFID tag; and
a database for processing information from said RFID receiver to allow or deny access to the locations and assets.

16. The system of claim 15, said comparator provides a first signal for selectively permitting entry into said location and a second signal permitting access to said at least one asset.

17. The system of claim 17, wherein said second signal is further adapted to also permit or deny removal of said at least one asset from said location.

18. The system of claim 17, wherein said second signal is further adapted to also permit or deny removal of said at least one asset from said location.
